(19) United States
(12) Patent Application Publication
(10) Pub. No.: US 2008/0249230 A1
(43) Pub. Date: Oct. 9, 2008

(54) Method for Treating Fibrous Substrates

(75) Inventors: Stephan Huffer, Ludwigshafen (DE); Darijo Mijolovic, Mannheim (DE); Karl Vill, Korschenbroich (DE); Matthias Kluglein, Ludwigshafen (DE); Gerhard Wolf, Ketsch (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/572,449

(22) PCT Filed: Sep. 18, 2004
(86) PCT No.: PCT/EP04/10498

§ 371 Date: Mar. 20, 2006

(30) Foreign Application Priority Data
Sep. 26, 2003 (DE) 10345094.7
Nov. 14, 2003 (DE) 10353557.8
Nov. 25, 2003 (DE) 10355402.5

(51) Int. Cl. C08L 33/02

(52) U.S. Cl. 524/522; 525/221; 524/556

(57) ABSTRACT

Fibrous substrates are treated with
(a) at least one oligomer of branched or straight-chain C₃-C₁₀-alkene having an average molecular weight Mₙ of up to 1200 g/mol,
(b) at least one emulsifier which is obtainable by copolymerization of
   (A) at least one ethylenically unsaturated dicarboxylic anhydride, derived from at least one dicarboxylic acid of 4 to 8 carbon atoms,
   (B) at least one oligomer of branched or straight-chain C₃-C₁₀-alkene, at least one oligomer having an average molecular weight Mₙ of up to 1200 g/mol,
   (C) at least one α-olefin of up to 16 carbon atoms and
   (D) optionally at least one ethylenically unsaturated comonomer,
   and optionally reaction with
   (E) at least one compound of the formula I a, I b, I c or I d

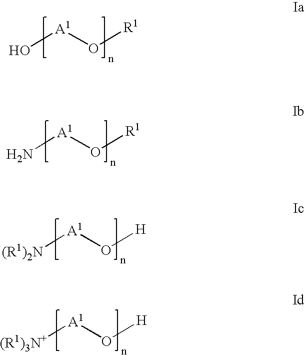

and, if appropriate, subsequent contact with water,
where, in formulae I a to I d,
A¹ are identical or different C₂-C₂₀-alkylene,
R¹ is linear or branched C₁-C₃₀-alkyl, phenyl or hydrogen, and
n is an integer from 1 to 200.

The present invention relates to a process for the treatment of fibrous substrates, wherein they are treated with
(a) at least one oligomer of branched or straight-chain C₃-C₁₀-alkene having an average molecular weight Mₙ of up to 1200 g/mol,
(b) at least one emulsifier which is obtainable by copolymerization of
   (A) at least one ethylenically unsaturated dicarboxylic anhydride, derived from at least one dicarboxylic acid of 4 to 8 carbon atoms,
   (B) at least one oligomer of branched or straight-chain C₃-C₁₀-alkene, at least one oligomer having an average molecular weight Mₙ of up to 1200 g/mol,
   (C) at least one α-olefin of up to 16 carbon atoms and
   (D) optionally at least one further ethylenically unsaturated comonomer, and optionally reaction with
   (E) at least one compound of the formula I a, I b, I c or I d

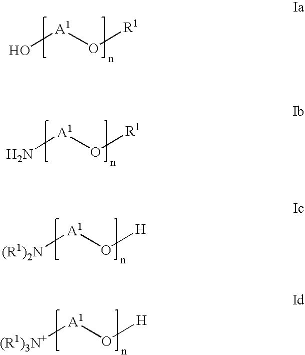

and if appropriate subsequent contact with water,
where, in the formulae I a to I d,
A¹ are identical or different C₂-C₂₀-alkylene,
R¹ is linear or branched C₁-C₃₀-alkyl; phenyl or hydrogen, and
n is an integer from 1 to 200.

The present invention furthermore relates to assistants for the treatment of fibrous substrates. The present invention furthermore relates to fibrous substrates produced by the novel process. The present invention furthermore relates to a copolymer which is particularly suitable for the preparation of novel assistants.

In the production of leather, the imparting of water repellency plays an important role for protecting the leather or a leather article from moisture and dirt. Further performance characteristics of the leather, for example the handle, are also influenced by the type of water repellency imparted. However, in the case of other fibrous substrates, for example textile, paper, board and artificial leather, the imparting of water repellency also plays an important role.

WO 95/07944 discloses copolymers of from 20 to 60 mol % of monoethylenically unsaturated C₄-C₆-dicarboxylic acids or anhydrides thereof with from 10 to 70 mol % of at least one oligomer of propene or of a branched 1-olefin, for example isobutene, and from 1 to 50 mol % of at least one monoethylenically unsaturated compound which is polymerizable with the abovementioned monomers, for example vinyl and alkyl allyl ethers, and the use thereof for the preparation of oil-soluble reaction products which are suitable as an additive for lubricants and fuels.

EP-A 1 316 564 discloses copolymers of maleic anhydride or derivatives of maleic anhydride with polyisobutene having a degree of polymerization of from 2 to 8. The copolymers disclosed are suitable, for example, as dispersants in lubricant compositions and as a gasoline additive, i.e. in nonaqueous media.

WO 03/23070 discloses fatliquoring agents for hides, which comprise, for example, polyisobutene having a molecular weight of 1000 g/mol or products which are prepared by an ene reaction from polyisobutene, preferably having a molecular weight of more than 1000 g/mol, and suitable enophiles, for example maleic anhydride (examples 1 to 3). When they are employed with conventional emulsifiers for the treatment of hides or leather, the polyisobutenes disclosed are suitable for the production of leather having a fatty handle. Leathers having a fatty handle are desired for numerous applications, but the leathers produced according to WO 03/23070 and having a fatty handle are not uniformly fatliquored over the total cross section but only on the surface, in particular on the flesh side. Imparting of water repellency in this manner is undesirable, for example, for upper leather.

It is an object of the present invention to provide a process for the treatment of fibrous substrates which permits good protection from moisture in combination with a pleasant handle and fatliquoring of the water repellent substrates which is distributed very uniformly over the cross section. It is furthermore an object of the present invention to provide assistants with which fibrous substrates can be readily treated. It is furthermore an object of the present invention to provide a process for the preparation of assistants, and it is an object of the present invention to provide treated fibrous substrates.

We have found that these objects are achieved by the process defined at the outset. The novel process starts from fibrous substrates. In the context of the present invention, examples of fibrous substrates are:
textile, which, in the context of the present invention, is to be understood as meaning textile fibers, textile sheet-like structures, textile semifinished and finished products and finished goods produced therefrom, which, in addition to textiles for the clothing industry, also comprise, for example, carpets and other home textiles and textile structures serving technical purposes. These also include unshaped structures, for example flocks, linear structures, such as strings, threads, yarns, lines, cords, ropes and twists, and three-dimensional structures, such as felts, woven fabrics, nonwovens and wadding. Textiles to be treated according to the invention may be of natural origin, for example wool, flax or in particular cotton, or synthetic, for example polyamide and polyester,
paper, board and cardboard boxes,
nonwovens, for example as an additive for finishes and floor polishes,
wood and wood composites, for example particle boards,
artificial leather, alcantara, leather fiber materials, i.e. leather fiber materials obtained from leather wastes which have been processed with a binder or resin to give a synthetically produced fiber structure,
   and particularly preferably
leather, which is to be understood as meaning animal hides or semifinished products pretanned and preferably tanned with the aid of optionally chrome tanning agents or without chromium, for example with mineral tanning agents, polymer tanning agents, synthetic tanning agents, vegetable tanning agents, resin tanning agents or combinations of at least two of the abovementioned tanning agents.

In an embodiment of the present invention, leather is animal hide (wet blue) or semifinished products tanned or pretanned with the aid of chrome tanning agents.

In a preferred embodiment of the present invention, leather is animal hide or semifinished products (wet white) tanned or pretanned without chromium.

According to the invention, fibrous substrates are treated with
(a) at least one oligomer of branched or straight-chain C₃-C₁₀-alkene, at least one oligomer having an average molecular weight Mₙ of up to 1200 g/mol, and
(b) at least one emulsifier.

Suitable oligomers (a) are oligomers of propylene or straight-chain or preferably branched C₄-C₁₀-olefins, at least one oligomer having an average molecular weight Mₙ of up to 1200 g/mol. Examples are oligomers of propylene, isobutene, 1-pentene, 2-methylbut-1-ene, 1-hexene, 2-methylpent-1-ene, 2-methylhex-1-ene, 2,4-dimethyl-1-hexene, diisobutene (mixture of 2,4,4-trimethyl-1-pentene and 2,4,4-trimethyl-2-pentene), 2-ethylpent-1-ene, 2-ethylhex-1-ene and 2-propylhept-1-ene, 1-octene, 1-decene and 1-dodecene, very particularly preferably isobutene, diisobutene and 1-dodecene. Oligomers (a) have an ethylenically unsaturated group which may be present in the form of a vinyl, vinylidene or alkylvinylidene group.

Co-oligomers of the abovementioned olefins with one another or with up to 20% by weight, based on (a), of vinylaromatics, such as styrene and α-methylstyrene, C₁-C₄-alkylstyrene, for example 2-, 3- and 4-methylstyrene and 4-tert-butylstyrene, are also suitable.

Particularly preferred oligomers (a) are oligopropylenes and oligoisobutenes having an average molecular weight Mₙ of up to 1200, preferably from 300 to 1000, particularly preferably at least 400, very particularly preferably at least 500, g/mol, for example determined by means of gel permeation chromatography (GPC).

In an embodiment of the present invention, oligomers (a) have a polydispersity M_{w}/Mₙ of from 1.1 to 10, preferably up to 3, particularly preferably from 1.5 to 1.8.

In an embodiment of the present invention, oligomers (a) have a bimodal molecular weight distribution with a maximum of Mₙ in the range from 500 to 1200 g/mol and a local maximum of Mₙ in the range from 2000 to 5000 g/mol.

Oligopropylenes and oligoisobutenes are known as such; oligoisobutenes are obtainable, for example, by oligomerization of isobutene in the presence of a Lewis acid catalyst, for example of a boron trifluoride catalyst, cf. for example DE-A 27 02 604. Suitable isobutene-containing starting materials are both isobutene itself and isobutene-containing C₄-hydrocarbon streams, for example refined C₄ fractions, C₄ cuts from the dehydrogenation of isobutane, C₄ cuts from steam crackers or FCCs (FCC: fluid catalyzed cracker), provided that the relevant C₄ cuts have been substantially freed from 1,3-butadiene present therein. Typically, the concentration of isobutene in C₄-hydrocarbon streams is from 40 to 60% by weight. Suitable C₄-hydrocarbon streams should as a rule comprise less than 500 ppm, preferably less than 200 ppm, of 1,3-butadiene.

The preparation of further oligomers (a) is known per se; methods are to be found, for example, in WO 96/23751 and in WO 99/67347, example 3.

According to the invention, a fibrous substrate is also treated with at least one emulsifier (b) which is obtainable by, preferably, free radical copolymerization of
(A) at least one ethylenically unsaturated dicarboxylic anhydride, derived from at least one dicarboxylic acid of 4 to 8 carbon atoms, for example maleic anhydride, itaconic anhydride, citraconic anhydride, methylenemalonic anhydride, preferably itaconic anhydride and maleic anhydride, very particularly preferably maleic anhydride;
(B) at least one oligomer of branched or straight-chain C₃-C₁₀-alkene, at least one oligomer having an average molecular weight Mₙ of up to 1200 g/mol, or
(C) at least one α-olefin of up to 16 carbon atoms, and
(D) optionally at least one further ethylenically unsaturated comonomer differing from (A) and (C)
   and
(E) optionally reaction with at least one compound I a, I b, I c or I d,
   whose carboxyl groups may have been at least partially esterified or amidated, and optionally contact with water.

Suitable oligomers (B) are oligomers of propylene or straight-chain or, preferably, branched C₄-C₁₀-olefins, at least one oligomer having an average molecular weight Mₙ of up to 1200 g/mol. Examples are oligomers of propylene, isobutene, 1-pentene, 2-methylbut-1-ene, 1-hexene, 2-methylpent-1-ene, 2-methylhex-1-ene, 2,4-dimethyl-1-hexene, diisobutene (mixture of 2,4,4-trimethyl-1-pentene and 2,4,4-trimethyl-2-pentene), 2-ethylpent-1-ene, 2-ethylhex-1-ene and 2-propylhept-1-ene, 1-octene, 1-decene and 1-dodecene, very particularly preferably oligomers of isobutene, diisobutene and 1-dodecene. Oligomers (B) have an ethylenically unsaturated group which may be present in the form of a vinyl, vinylidene or alkylvinylidene group.

Co-oligomers of the abovementioned olefins with one another or with up to 20% by weight, based on (B), of vinylaromatics, such as styrene and α-methylsytrene, C₁-C₄-alkylstyrene, for example 2-, 3- and 4-methylstyrene and 4-tert-butylstyrene, are also suitable.

Particularly preferred oligomers (B) are oligopropylenes and oligoisobutenes having an average molecular weight Mₙ of up to 1200, preferably from 300 to 1000, particularly preferably at least 400, very particularly preferably at least 500, g/mol, for example determined by means of gel permeation chromatography (GPC).

In an embodiment of the present invention, oligomers (B) have a polydispersity M_{w}/Mₙ of from 1.1 to 10, preferably up to 5, particularly preferably from 1.5 to 1.8.

In an embodiment of the present invention, oligomers (B) have a bimodal molecular weight distribution with a maximum of Mₙ in the range from 500 to 1200 g/mol and a local maximum of Mₙ in the range from 2000 to 5000 g/mol.

Oligomer (B) may be identical to or different from oligomer (a).

In an embodiment of the present invention, oligomer (B) and oligomer (a) are identical.

α-Olefins of up to 16 carbon atoms which are used as comonomer (C) are selected from propylene, 1-butene, isobutene, 1-pentene, 4-methylbut-1-ene, 1-hexene, diisobutene (mixture of 2,4,4-trimethyl-1-pentene and 2,4,4-trimethyl-2-pentene), 1-heptene, 1-octene, 1-decene, 1-dodecene, 1-tetradecene and 1-hexadecene; isobutene, diisobutene and 1-dodecene are particularly preferred.

For the preparation of emulsifier (b) used according to the invention, (A), (B) and (C) can be copolymerized with one another. Furthermore, for the preparation of novel emulsifier (b), (A), (B) and (C) can be copolymerized with one another and reacted with (E) or (A), (B) and (C) and a further comonomer (D) can be copolymerized with one another, or (A) and (B) and (C) and a further comonomer (D) can be copolymerized with one another and reacted with (E).

If it is desired to use such an emulsifier (b) whose carboxyl groups have been at least partially esterified or amidated, at least one compound of the formula I a to I d, preferably I a,

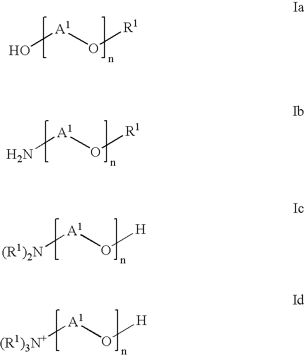

where
A¹ is C₂-C₂₀-alkylene, for example —(CH₂)₂—, —CH₂—CH(CH₃)—, —(CH₂)₃—, —CH₂—CH(C₂H₅)—, —(CH₂)₄—, —(CH₂)₅—, —(CH₂)₆—, preferably C₂-C₄-alkylene; in particular —(CH₂)₂—, —CH₂—CH(CH₃)— and —CH₂—CH(C₂H₅)—;
R¹ is phenyl,
   hydrogen
   or, preferably, linear or branched C₁-C₃₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-hexadecyl, n-octadecyl or n-eicosyl; particularly preferably C₁-C₄-alkyl, such as methyl, ethyl, n-propyl, isopropyl, n-butyl, isobutyl, sec-butyl and tert-butyl, very particularly preferably methyl;
n is an integer from 1 to 200, preferably from 4 to 20,
   is chosen as compound (E).

The groups A¹ can of course be different only when n is greater than 1 or when different compounds of the formula I a to I d are used.

Particular examples of compounds of the formula I a are
polyethylene glycols of the formula HO—(CH₂CH₂O)ₘ—CH₃, where m=1 to 200, preferably 4 to 100, particularly preferably 4 to 50, which have been blocked with methyl terminal groups,
block copolymers of ethylene oxide, propylene oxide and/or butylene oxide which have been blocked with methyl terminal groups and have a molecular weight Mₙ of from 300 to 5000 g/mol
random copolymers of ethylene oxide, propylene oxide and/or butylene oxide which have been blocked with methyl terminal groups and have a molecular weight Mₙ of from 300 to 5000 g/mol
alkoxylated C₂- to C₃₀-alcohols, in particular fatty alcohol alkoxylates, oxo alcohol alkoxylates or Guerbet alcohol alkoxylates, it being possible for the alkoxylation to be carried out with ethylene oxide, propylene oxide and/or butylene oxide; examples are
C₁₃-C₁₅-oxo alcohol ethoxylates having 3 to 30 ethylene oxide units,
C₁₃-oxo alcohol ethoxylates having 3 to 30 ethylene oxide units,
C₁₂-C₁₄-fatty alcohol ethoxylates having 3 to 30 ethylene oxide units,
C₁₀-oxo alcohol ethoxylates having 3 to 30 ethylene oxide units,
C₁₀-Guerbet alcohol ethoxylates having 3 to 30 ethylene oxide units,
C₉-C₁₁-oxo alcohol alkoxylates having 2 to 20 ethylene oxide units, 2 to 20 propylene oxide units and/or 1 to 5 butylene oxide units,
C₁₃-C₁₅-oxo alcohol alkoxylates having 2 to 20 ethylene oxide units, 2 to 20 propylene oxide units and/or 1 to 5 butylene oxide units,
C₄-C₂₀-alcohol ethoxylates having 2 to 20 ethylene oxide units.

Preferred examples of compounds of the formula I b are polyethyleneglycolamines of the formula H₂N—(CH₂CH₂O)ₘ—CH₃, where m=1 to 200, preferably 4 to 100, particularly preferably 4 to 50, which have been blocked with methyl terminal groups.

If it is desired to carry out a reaction with compound I d, compound I c can be reacted with alkylating agents, for example halides or sulfates of the formula R¹—Y, where Y is selected from Cl, Br and I, or (R¹)₂SO₄. Depending on the use of the alkylating agent or agents, compound I d with Y, SO₄²⁻ or R¹—SO₄⁻ as an opposite ion is obtained.

In an embodiment of the present invention, mixtures of different components (E), for example of the formula I a, are used. In particular, it is possible to use those mixtures of compounds of the formula I a in which—based in each case on the mixture—at least 95, preferably at least 98, to not more than 99.8, mol % of R¹ are C₁-C₃₀-alkyl and at least 0.2 mol % and not more than 5, preferably not more than 2, mol % are hydrogen.

In an embodiment of the present invention, for the preparation of the emulsifier (b) used according to the invention, the reaction solution is brought into contact with water after the preferably free radical copolymerization and, if appropriate, the reaction with (E), it also being possible for the water to comprise Brønsted acid or, preferably, Brønsted base. Examples of Brønsted acids are sulfuric acid, hydrochloric acid, tartaric acid and citric acid. Examples of Brønsted base are alkali metal hydroxide, for example NaOH and KOH, alkali metal carbonate, for example Na₂CO₃ and K₂CO₃, alkali metal bicarbonate, for example NaHCO₃ and KHCO₃, ammonia, amines, for example trimethylamine, triethylamine, diethylamine, ethanolamine, N,N-diethanolamine, N,N,N-triethanolamine and N-methylethanolamine.

In another embodiment of the present invention, contact with water can be effected as early as during the preferably free radical copolymerization.

In another embodiment of the present invention, emulsifier (b) is brought into contact with water only during the novel treatment of fibrous substrate.

The monomer or monomers (D) which can optionally be used for the preparation of emulsifiers (b) used according to the invention differs or differ from (A), (B) and (C). Examples of preferred monomers (D) are:

C₃-C₈-carboxylic acids or carboxylic acid derivatives of the formula II

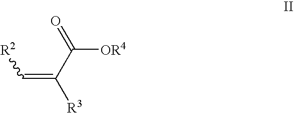

carboxamides of the formula III

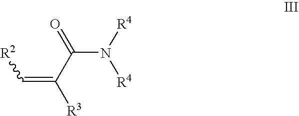

acyclic amides of the formula IV a and cyclic amides of the formula IV b

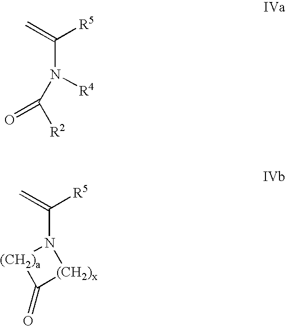

C₁-C₂₀-alkyl vinyl ethers, such as methyl vinyl ether, ethyl vinyl ether, n-propyl vinyl ether, isopropyl vinyl ether, n-butyl vinyl ether, isobutyl vinyl ether, 2-ethylhexyl vinyl ether or n-octadecyl vinyl ether,
N-vinyl derivatives of nitrogen-containing aromatic compounds, preferably N-vinylimidazole, 2-methyl-1-vinylimidazole, N-vinyloxazolidone, N-vinyltriazole, 2-vinylpyridine, 4-vinylpyridine, 4-vinylpyridine N-oxide, N-vinylimidazoline, N-vinyl-2-methylimidazoline,
α,β-unsaturated nitrites, for example acrylonitrile or methacrylonitrile,
alkoxylated unsaturated ethers of the formula V

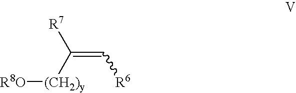

esters and amides of the formula VI

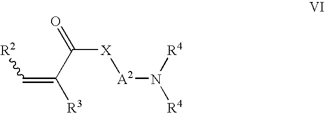

unsaturated esters of the formula VII

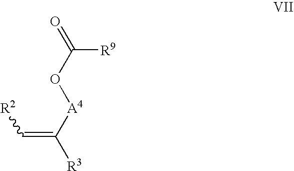

vinylaromatic compounds of the formula VIII

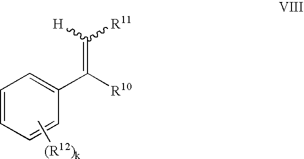

comonomers containing phosphate, phosphonate, sulfate and sulfonate groups, for example 2{(meth)acryloyloxy}ethyl phosphate or 2-(meth)acrylamido-2-methyl-1-propanesulfonic acid,
linear or branched α-olefins of 18 to 40, preferably up to 24, carbon atoms, for example 1-octadecene, 1-eicosene, α-C₂₂H₄₄, α-C₂₄H₄₈ and mixtures of the abovementioned α-olefins.

The variables are defined as follows:
R² and R³ are identical or different and are selected from straight-chain or branched C₁-C₅-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl and isoamyl, particularly preferably C₁-C₄-alkyl, such as methyl, ethyl, n-propyl, isopropyl, n-butyl, isobutyl, sec-butyl and tert-butyl;
   and in particular hydrogen;
R⁴ are identical or different and are branched or straight-chain C₁-C₂₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl or n-eicosyl; particularly preferably C₁-C₄-alkyl, such as methyl, ethyl, n-propyl, isopropyl, n-butyl, isobutyl, sec-butyl and tert-butyl;
   or particularly preferably hydrogen;
R⁵ is hydrogen or methyl,
x is an integer from 2 to 6, preferably from 3 to 5;
y is an integer selected from 0 and 1, preferably 1;
a is an integer from 0 to 6, preferably from 0 to 2;
R⁶ and R⁷ are identical or different and are selected from hydrogen and straight-chain or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, preferably C₁-C₄-alkyl, such as methyl, ethyl, n-propyl, isopropyl, n-butyl, isobutyl, sec-butyl and tert-butyl, very particularly preferably methyl;
X is oxygen or N—R⁴;
R⁸ is [A³-O]ₙ—R⁴,
R⁹ is selected from straight-chain or branched C₁-C₂₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl, n-hexadecyl, n-octadecyl and n-eicosyl; preferably C₁-C₁₄-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl,
   and in particular hydrogen or methyl;
R¹⁰ and R¹¹, independently of one another, are each hydrogen, methyl or ethyl, and R¹⁰ and R¹¹ are each preferably hydrogen;
R¹² is methyl or ethyl;
k is an integer from 0 to 2, preferably 0;
A² and A³ are identical or different and are C₂-C₂₀-alkylene, for example —(CH₂)₂—, —CH₂—CH(CH₃)—, —(CH₂)₃—, —CH₂—CH(C₂H₅)—, —(CH₂)₄—, —(CH₂)₅—, —(CH₂)₆—, preferably C₂-C₄-alkylene; in particular —(CH₂)₂—, —CH₂—CH(CH₃)— and —(CH₂)₃—;
A⁴ is C₁-C₂₀-alkylene, for example —CH₂—, —CH(CH₃), —CH(C₆H₅)—, —C(CH₃)₂—, —(CH₂)₂—, —CH₂—CH(CH₃)—, —(CH₂)₃—, —CH₂—CH(C₂H₅)—, —(CH₂)₄—, —(CH₂)₅—, —(CH₂)₆—, preferably C₂-C₄-alkylene; in particular —(CH₂)₂—, —CH₂—CH(CH₃)— and —(CH₂)₃—,
   or in particular a single bond.

The remaining variables are defined as above.

Compounds of the formula III which are selected by way of example are (meth)acrylamides, such as acrylamide, N-methylacrylamide, N,N-dimethylacrylamide, N-ethylacrylamide, N-propylacrylamide, N-tert-butylacrylamide, N-tert-octylacrylamide, N-undecylacrylamide or the corresponding methacrylamides.

Compounds of the formula IV a which are selected by way of example are N-vinylcarboxamides, such as N-vinylformamide, N-vinyl-N-methylformamide, N-vinylacetamide or N-vinyl-N-methylacetamide; typical compounds of the formula IV b which are selected by way of example are N-vinylpyrrolidone, N-vinyl-4-piperidone and N-vinyl-ε-caprolactam.

Compounds of the formula VI which are selected by way of example are (meth)acrylates and (meth)acrylamides, such as N,N-dialkylaminoalkyl(meth)acrylates or N,N-dialkylaminoalkyl(meth)acrylamides; examples are N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, 2-(N,N-dimethylamino)ethylacrylamide, 2-(N,N-dimethylamino)ethylmethacrylamide, 2-(N,N-diethylamino)ethylacrylamide, 2-(N,N-diethylamino)ethylmethacrylamide, 3-(N,N-dimethylamino)propylacrylamide and 3-(N,N-dimethylamino)propylmethacrylamide.

Compounds of the formula VII which are selected by way of example are vinyl acetate, allyl acetate, vinyl propionate, vinyl butyrate, vinyl 2-ethylhexanoate or vinyl laurate. Vinylaromatic compounds of the formula VIII which are selected by way of example are α-methylstyrene, para-methylstyrene and in particular styrene.

The following are very particularly preferably used as comonomer (D): acrylic acid, 1-octadecene, methacrylic acid, methyl acrylate, methyl methacrylate, acrylamide, vinyl n-butyl ether, vinyl isobutyl ether, styrene, N-vinylformamide, N-vinylpyrrolidone, 1-vinylimidazole and 4-vinylpyridine.

In relation to (A), (B), (C) and if appropriate (D), the copolymers used as emulsifiers (b) may be block copolymers, alternating copolymers or random copolymers, alternating copolymers being preferred.

In an embodiment of the present invention, the novel process is carried out in aqueous liquor.

In an embodiment of the present invention, the anhydride groups of copolymer used as emulsifier (b) are present in completely or partly hydrolyzed and, if appropriate, neutralized form after the polymerization.

In an embodiment of the present invention, the anhydride groups of copolymer used as emulsifier (b) are present as anhydride groups after the copolymerization.

In an embodiment, a weight ratio of oligomer (a) to emulsifier (b) of from 0.1:1 to 100:1, preferably from 0.5:1 to 0:1, is chosen.

In an embodiment, a weight ratio of oligomer (a) to emulsifier (b) of from 1:1 to 100:1, preferably from 10:1 to 50:1, is chosen.

In an embodiment of the present invention, the molar ratios in emulsifiers (b) used according to the invention are
(A) in the range from 5 to 60, preferably from 10 to 55, mol %,
(B) in the range from 1 to 95, preferably from 5 to 70, mol %,
(C) in the range from 1 to 60, preferably from 10 to 55, mol %,
(D) in the range from 0 to 70, preferably from 1 to 50, mol %, based in each case on copolymer, the sum of (A), (B), (C) and (D) being 100 mol %, and
(E) in the range from 0 to 50, preferably from 1 to 30, particularly preferably from 2 to 20, mol %, based on all carboxyl groups of copolymer.

The novel process can be carried out as tanning or, preferably, as retanning, referred to below as novel tanning process and novel retanning process, respectively. However, the novel process can also be carried out as a separate treatment process.

The novel tanning process is carried out in general in such a way that novel dispersion or novel copolymer is added in one portion or in a plurality of portions immediately before or during the tanning. The novel tanning process is preferably carried out at a pH of from 2.5 to 5, it frequently being observed that the pH increases by about 0.3 to three units while the novel tanning process is being carried out. The pH can also be increased by about 0.3 to three units by adding basifying agents.

The novel tanning process is carried out in general at from 10 to 45° C., preferably from 20 to 30° C. A duration of from 10 minutes to 12 hours, preferably from one to three 10 hours, has proven useful. The novel tanning process can be carried out in any desired vessels customary in tanneries, for example by drumming in barrels or in rotated drums.

For carrying out the novel tanning process, (a) and (b) can be metered together or separately. Preferably, (a) and (b) are metered together. Particularly preferably, (a) and (b) are metered in the form of an aqueous dispersion, dispersions being understood below as meaning aqueous emulsions, suspensions and also aqueous solutions of (a) and (b) having a clear appearance.

In a variant of the novel tanning process, (a) and (b) are used together with one or more conventional tanning agents, for example with chrome tanning agents, mineral tanning agents, preferably with syntans, polymer tanning agents or vegetable tanning agents, as described, for example, in Ullmann's Encyclopedia of Industrial Chemistry, Volume A15, pages 259 to 282 and in particular page 268 et seq., 5th Edition, (1990), Verlag Chemie Weinheim.

The novel process for the treatment of leather can preferably be carried out as a process for the retanning of leather using (a) and (b). The novel retanning process starts from semifinished products tanned conventionally, i.e. for example with chrome tanning agents, mineral tanning agents, preferably with polymer tanning agents, aldehydes, syntans or resin tanning agents, or semifinished products produced according to the invention using (a) and (b). For carrying out the novel retanning, (a) and (b) are allowed to act according to the invention on semifinished products.

For carrying out the novel retanning process, (a) and (b) can be metered together or separately. Preferably, (a) and (b) are metered together. Particularly preferably, (a) and (b) are metered in the form of an aqueous dispersion.

The novel retanning process can be carried out under otherwise conventional tannery conditions. One or more, i.e. 2 to 6, soaking steps are expediently chosen and washing with water can be effected between the soaking steps. The temperature during the individual soaking steps is in each case from 5 to 60° C., preferably from 20 to 45° C. From 0.5 to 10% by weight of the sum of oligomer (a) and emulsifier (b) can be metered, the percentages by weight being based on the split weight of the leather treated according to the invention or of the semifinished products treated according to the invention.

Of course, compositions usually used during the tanning or retanning, for example fatliquors, polymer tanning agents, fatliquoring agents based on acrylate and/or methacrylate or based on silicones, retanning agents based on resin and vegetable tanning agents, fillers, leather dyes or emulsifiers or combinations of at least two of the abovementioned substances, can be added for carrying out the novel tanning process or retanning process.

In an embodiment of the novel retanning process, further fatliquoring agents and water repellents can be used.

In another embodiment of the novel retanning process, the use of further fatliquoring agents and water repellents is dispensed with.

In an embodiment of the present invention, the addition of further water repellents or fatliquoring agents based on silicones is dispensed with.

In another embodiment of the present invention, aqueous dispersion of (a) and (b) is sprayed onto fibrous substrate, in particular paper, board or cardboard boxes.

In another embodiment of the present invention, fibrous substrates, in particular textile, are treated with (a) and (b), for example by the exhaustion method.

Fibrous substrate is rendered water repellent by the novel treatment.

The present invention furthermore relates to fibrous substrates, preferably leathers, for example based on wet-blue, and in particular leather based on wet-white, produced by the novel treatment process. They have particularly good water repellency, which is characterized by uniform fatliquoring over the total cross section of the novel fibrous substrate.

The present invention furthermore relates to leather produced by the novel tanning process or the novel retanning process or by a combination of novel tanning process and novel retanning process. The novel leathers have a generally advantageous quality, for example they have a particularly pleasant handle. The novel leathers comprise copolymer described above, which has penetrated particularly well into micro-regions of the elementary fibers.

A further aspect of the present invention is the use of the novel fibrous substrates, for example for the production of automotive parts or packagings.

A further aspect of the present invention is the use of the novel leathers for the production of articles of clothing, pieces of furniture or automotive parts. In the context of the present invention, articles of clothing include, for example, jackets, pants, shoes, in particular shoe soles, belts or suspenders. In association with the present invention, pieces of furniture include all those pieces of furniture which comprise leather components. Examples are seating furniture, such as seats, chairs and sofas. Examples of automotive parts are automobile seats.

A further aspect of the present invention comprises articles of clothing comprising the novel substrates or produced from novel substrates, in particular from novel leather or novel textile. A further aspect of the present invention comprises furniture comprising the novel leather or produced from novel leather. A further aspect of the present invention comprises automotive parts comprising the novel leather or produced from novel leather.

The present invention furthermore relates to assistants comprising
(a) at least one oligomer of branched or straight-chain C₃-C₁₀-alkene having an average molecular weight Mₙ of up to 1200 g/mol,
(b) at least one emulsifier which is obtainable by copolymerization of
   (A) at least one ethylenically unsaturated dicarboxylic anhydride, derived from at least one dicarboxylic acid of 4 to 8 carbon atoms,
   (B) at least one oligomer of branched or straight-chain C₃-C₁₀-alkene, at least one oligomer having an average molecular weight Mₙ of up to 1200 g/mol,
   (C) at least one α-olefin of up to 16 carbon atoms and
   (D) optionally at least one further ethylenically unsaturated comonomer,
      and optionally reaction with
(E) at least one compound of the formula I a, I b, I c or I d

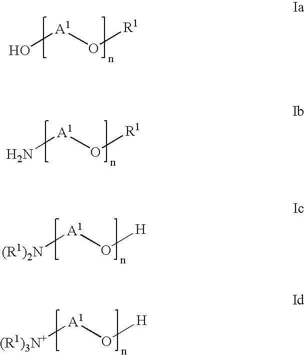

where, in formulae I a and Id,
A¹ are identical or different C₂-C₂₀-alkylene,
R¹ is linear or branched C₁-C₃₀-alkyl, phenyl or hydrogen, and
n is an integer from 1 to 200,
and if appropriate subsequent contact with water.

The variables are defined as above. The groups A¹ can of course be different only when n is greater than 1 or when different compounds of the formula I a and/or I b are used.

By using the novel assistants, the novel process for the treatment of fibrous substrates can be carried out in a particularly simple manner. The metering is particularly convenient, and the fatliquoring of fibrous substrates treated according to the invention is particularly uniform.

The present invention furthermore relates to a process for the preparation of novel assistants, also referred to below as novel preparation process. The novel preparation process can be carried out in such a way that oligomer (a) and emulsifier (b) are mixed with one another. If water has been added for the preparation of (b), the water added preferably remains in the emulsifier (b) so that the novel assistants are preferably obtained in the form of aqueous dispersions.

In a special embodiment of the novel preparation process, oligomer (a) and emulsifier (b) are mixed with one another and the mixture is passed through a homogenizer, for example a gap homogenizer. Particularly stable aqueous dispersions, which are likewise a subject of the present invention, are obtained.

In an embodiment of the present invention, water is added in an amount such that the water content of the novel dispersion of (a) and (b) is from 30 to 99.5% by weight, based on the novel assistant, of water.

In an embodiment of the present invention, novel assistants have a pH of from 3 to 10, preferably from 5 to 8.

Of course, further substances, for example further emulsifiers, can be added to novel assistants, but preferably no further emulsifiers are added to novel assistants.

Emulsifiers (b) can be prepared by copolymerization, preferably free radical copolymerization, of
(A) at least one ethylenically unsaturated dicarboxylic anhydride, derived from at least one dicarboxylic acid of 4 to 8 carbon atoms,
(B) at least one oligomer of branched or straight-chain C₃-C₁₀-alkene, at least one oligomer having an average molecular weight Mₙ of up to 1200 g/mol,
(C) at least one α-olefin of up to 16 carbon atoms and
(D) optionally at least one further ethylenically unsaturated comonomer,
   and optionally reaction with
(E) at least one compound of the formula I a, I b, I c or I d

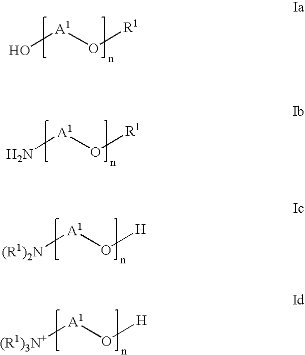

where, in formulae I a to I d,
A¹ are identical or different C₂-C₂₀-alkylene,
R¹ is linear or branched C₁-C₃₀-alkyl, phenyl or hydrogen, and
n is an integer from 1 to 200,
and if appropriate subsequent contact with water.

For the preparation of substances used according to the invention as emulsifier (b), the following procedure can expediently be adopted.

In an embodiment of the present invention, copolymers are prepared by copolymerization of (A), (B), (C) and, if appropriate, (D) and can be partially esterified or amidated with (E) after the copolymerization and are used according to the invention as emulsifier (b).

In another embodiment of the present invention, partially esterified or amidated copolymers are prepared by copolymerization of (A), (B), (C) and, if appropriate, (D) in the presence of (E) and are used according to the invention as emulsifier (b).

In an embodiment of the present invention, mixtures of different components (E), for example of the formula I a, are used. In particular, it is possible to use those mixtures of compounds of the formula I a in which—based in each case on the mixture—at least 95, preferably at least 98, to not more than 99.8, mol % of R¹ are C₁-C₃₀-alkyl and at least 0.2 mol % and not more than 5, preferably not more than 2, mol % are hydrogen.

If it is desired to carry out a reaction with compound I d, compound I c can be reacted with alkylating agents, for example halides or sulfates of the formula R¹—Y, where Y is selected from Cl, Br and I, or (R¹)₂SO₄. Depending on the use of the alkylating agent or agents, compound I d with Y, SO₄²⁻ or R¹—SO₄⁻ as an opposite ion is obtained.

Instead of carrying out the reaction with compound I d, it is possible, in the context of the present invention, also to carry out the reaction with I c and to react with alkylating agent after the copolymerization and, if appropriate, the contact with water.

In an embodiment of the present invention, dicarboxylic anhydrides (A) incorporated in the form of polymerized units in emulsifiers (b) used according to the invention are present partly or completely in hydrolyzed and, if appropriate, neutralized form.

In an embodiment of the present invention, emulsifiers (b) used according to the invention comprise at least one comonomer (D) incorporated in the form of polymerized units, which is selected from

ethylenically unsaturated C₃-C₈-carboxylic acids or carboxylic acid derivatives of the formula II

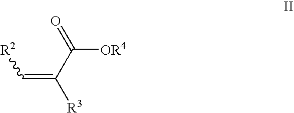

carboxamides of the formula III

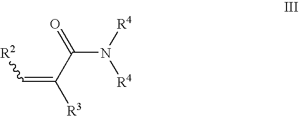

acyclic amides of the formula IV a or cyclic amides of the formula IV b

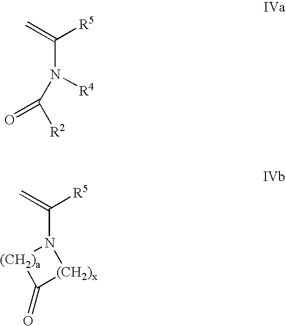

C₁-C₂₀-alkyl vinyl ethers,
N-vinyl derivatives of nitrogen-containing aromatic compounds,
α,β-unsaturated nitrites,
alkoxylated unsaturated ethers of the formula V

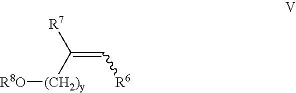

esters or amides of the formula VI

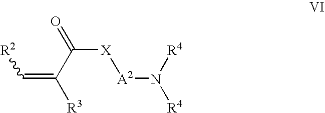

unsaturated esters of the formula VII

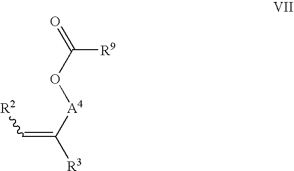

vinylaromatic compounds of the formula VIII

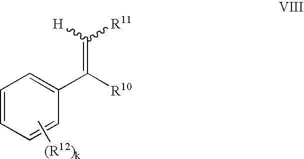

comonomers containing phosphate, phosphonate, sulfate and sulfonate groups,
linear or branched α-olefins of 18 to 40, preferably up to 24, carbon atoms, in particular 1-octadecene, 1-eicosene, α-C₂₂H₄₄, α-C₂₄H₄₈ and mixtures of the abovementioned α-olefins;
where, in the formulae,
R² and R³ are identical or different and are selected from hydrogen and straight-chain or branched C₁-C₅-alkyl and COOR⁴,
R⁴ are identical or different and are selected from hydrogen and branched or straight-chain C₁-C₂₂-alkyl,
R⁵ is hydrogen or methyl,
x is an integer from 2 to 6,
y is an integer selected from 0 and 1,
a is an integer from 0 to 6,
R⁶ and R⁷ are identical or different and are selected from hydrogen and straight-chain or branched C₁-C₁₀-alkyl,
X is oxygen or N—R⁴,
R⁸ is [A³-O]ₙ—R⁴,
R⁹ are identical or different and are selected from hydrogen and straight-chain or branched C₁-C₁₀-alkyl,
R¹⁰ and R¹¹, independently of one another, are each hydrogen, methyl or ethyl, and R¹⁰ and R¹¹ are preferably each hydrogen,
R¹² is methyl or ethyl,
k is an integer from 0 to 2, preferably 0,
A² and A³ are C₂-C₂₀-alkylene,
A⁴ is C₁-C₂₀-alkylene or a single bond
   and the remaining variables are defined as above.

In an embodiment of the present invention, the molar ratios of comonomers incorporated in the form of polymerized units in the novel emulsifier (b) are
(A) in the range from 5 to 60, preferably from 10 to 55, mol %,
(B) in the range from 1 to 95, preferably from 5 to 70, mol %,
(C) in the range from 1 to 60, preferably from 10 to 55, mol %,
(D) in the range from 0 to 70, preferably from 1 to 50, mol %, based in each case on copolymer, the sum of (A), (B), (C) and (D) being 100 mol %, and
(E) in the range from 0 to 50, preferably from 1 to 30, particularly preferably from 2 to 20, mol %, based on all carboxyl groups of the copolymer.

In an embodiment of the present invention, copolymers of (A), (B), (C) and, if appropriate, (D) which are used according to the invention as emulsifier (b) have an average molar mass M_{w} of from 1000 to 50 000, preferably from 1500 to 25 000, g/mol, determined, for example, by gel permeation chromatography using dimethylacetamide as a solvent and polymethyl methacrylate as a standard.

In relation to (A), (B), (C) and, if appropriate, (D), copolymers of (A), (B), (C) and, if appropriate, (D) and (E) which are used according to the invention as emulsifier (b) may be block copolymers, alternating copolymers or random copolymers, alternating copolymers being preferred.

The polydispersity M_{w}/Mₙ of copolymers of (A), (B), (C) and, if appropriate, (D) and (E) which are used according to the invention as emulsifier (b) is in general from 1.1 to 20, preferably from 2 to 10.

In an embodiment of the present invention, copolymers of (A), (B), (C) and, if appropriate, (D) and (E) which are used according to the invention as emulsifier (b) have Fikentscher K values of from 5 to 100, preferably from 8 to 30 (measured according to H. Fikentscher at 25° C. in cyclohexanone and at a polymer concentration of 2% by weight).

In an embodiment of the present invention, emulsifiers (b) used according to the invention may comprise comonomer (B) not incorporated in the form of polymerized units, for example in amounts of from 1 to 50% by weight, based on the total weight of emulsifier.

The preparation of copolymers of (A), (B), (C) and, if appropriate, (D) and (E) which are used according to the invention as emulsifier (b) starts from (A), (B), (C) and, if appropriate, (D), which are copolymerized with one another, preferably by free radical copolymerization, and, if appropriate, are reacted with (E). If it is desired, the reaction with (E) can be effected before, during or after the copolymerization. Contact with water can be effected during or, preferably, after the copolymerization. However, it is also possible to dispense with contact with water for the preparation of copolymer used according to the invention as emulsifier (b).

In a special embodiment of the present invention, a free radical copolymerization of (A), (B), (C) and, if appropriate, (D) is first carried out and reaction with (E) is then effected.

In another special embodiment of the present invention, the free radical copolymerization of (A), (B), (C) and, if appropriate, (D) is carried out in the presence of the total amount or portions of the compound (E) to be used.

In another special embodiment of the present invention, (A) and, if appropriate, (D) are first reacted with (E) and free radical copolymerization with (B) and (C) is then effected.

If a reaction of copolymer of (A), (B), (C) and, if appropriate, (D) with (E) or a free radical copolymerization in the presence of (E) is desired, the total amount of (E) is then calculated so that complete conversion of (E) is assumed and up to 50, preferably from 1 to 30, particularly preferably from 2 to 20, mol %, based on all carboxyl groups of the copolymer, of (E) are used. In the context of the present invention, the term “all carboxyl groups present in the polymer” is to be understood as meaning those carboxyl groups from polymerized comonomers (A) and, if appropriate, (D), which are present as anhydride, as C₁-C₄-alkyl ester or as carboxylic acid.

The free radical copolymerization is advantageously initiated by initiators, for example peroxides or hydroperoxides. Examples of peroxides and hydroperoxides are di-tert-butyl peroxide, tert-butyl peroctanoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide and dicyclohexyl peroxodicarbonate. The use of redox initiators is also suitable, for example combinations of hydrogen peroxide or sodium peroxodisulfate or one of the abovementioned peroxides with a reducing agent. Examples of suitable reducing agents are: ascorbic acid, tartaric acid, Fe(II) salts, for example FeSO₄, sodium bisulfite and potassium bisulfite.

Other suitable initiators are azo compounds, such as 2,2′-azobisisobutyronitrile, 2,2′-azobis(2-methylpropionamidine) dihydrochloride and 2,2′-azobis(4-methoxy-2,4-dimethylvaleronitrile).

In general, initiator is used in amounts of from 0.1 to 20, preferably from 0.2 to 15, % by weight, based on the mass of all comonomers.

The copolymerization can be carried out in the presence or absence of solvents and precipitating agents. Suitable solvents for the free radical copolymerization are polar solvents inert to acid anhydride, e.g. acetone, tetrahydrofuran and dioxane. Suitable precipitating agents are, for example, toluene, ortho-xylene, meta-xylene and aliphatic hydrocarbons.

In a preferred embodiment, the procedure is effected in the absence of a solvent or in the presence of only small amounts of solvent, i.e. from 0.1 to not more than 10% by weight, based on the total mass of comonomers (A), (B), (C) and, if appropriate, (D). Solvents are to be understood as meaning substances which are inert under the conditions of the copolymerization or of the esterification or amide formation, in particular aliphatic and aromatic hydrocarbons, such as cyclohexane, n-heptane, isododecane, benzene, toluene, ethylbenzene, xylene as an isomer mixture, meta-xylene and ortho-xylene. If the reaction with (E) is effected without an acidic catalyst or if the reaction with (E) is dispensed with, the free radical copolymerization and, if appropriate, reaction with (E) can also be carried out in solvents selected from ketones, such as acetone, methyl ethyl ketone or cyclic or acyclic ethers, for example tetrahydrofuran or di-n-butyl ether.

The copolymerization and, if appropriate, the reaction with (E) are preferably carried out in the absence of oxygen, for example in a nitrogen or argon atmosphere, preferably in a nitrogen stream.

For the free radical copolymerization and, if appropriate, the reaction with (E), conventional apparatuses may be used, for example autoclaves and kettles.

The comonomers may be added in different sequences.

In an embodiment, a mixture of (E) and (A) is initially taken and initiator and simultaneously (B), (C) and, if appropriate, (D) are added. It is preferable to add (B) and (C) and, if appropriate, (D) by a feed method.

In another embodiment, a mixture of (E) and (A) is initially taken and initiator and simultaneously (B) and (C) and, if appropriate, (D) are added by a feed method, initiator, (B) and (C) and, if appropriate, (D) each being dissolved in (E).

In another embodiment, a mixture of (E) and (A) is initially taken and initiator and (B), (C) and (D) are added by a feed method, the feed rates of (B), (C) and (D) being chosen to be different.

In another embodiment, a mixture of (E) and (A) is initially taken and initiator and (B), (C) and (D) are added by a feed method, the feed rates of (B), (C) and (D) being chosen to be identical.

In another embodiment, (A) and, if appropriate, (D) are initially taken and initiator and (B) and (C) are added by a feed method and, if appropriate, reaction with (E) is then effected.

In another embodiment, (A) is initially taken and initiator, (B), (C) and, if appropriate, (D) are added by a feed method and, if appropriate, reaction with (E) is then effected.

In another embodiment, (A) and (B) are initially taken and initiator and (c) are added by a feed method and, if appropriate, reaction with (E) is then effected.

In another embodiment, (B), (C) and, if appropriate, (D) are initially taken and initiator and (A) are added by a feed method and, if appropriate, reaction with (E) is then effected.

In another embodiment, (B) and (C) are initially taken and initiator, (A) and, if appropriate, (D) are added by a feed method and, if appropriate, reaction with (E) is then effected.

In another embodiment, (B) and, if appropriate, (D) are initially taken and initiator, (A) and, if appropriate, (C) are added by a feed method and, if appropriate, reaction with (E) is then effected.

In another embodiment, (A), (B), (C) and, if appropriate, (E) are initially taken and initiator and (D) are added by a feed method. (A), (B) and, if appropriate, (E) can also be initially taken in a solvent.

In an embodiment, further initiator is added during the addition of (B), (C) and, if appropriate, (D).

In an embodiment, further initiator is added during the addition of (A) and, if appropriate, (D).

In an embodiment, the temperature for the copolymerization of (A), (B), (C) and, if appropriate, (D) is from 80 to 300° C., preferably from 90 to 200° C.

The pressure is, for example, from 1 to 15, preferably from 1 to 10, bar.

It is possible to use regulators, for example C₁- to C₄-aldehydes, formic acid and organic SH-comprising compounds, such as 2-mercaptoethanol, 2-mercaptopropanol, mercaptoacetic acid, tert-butyl mercaptan or n-dodecyl mercaptan. Polymerization regulators are generally used in amounts of from 0.1 to 10% by weight, based on the total mass of the comonomers used. Preferably, regulators are not used.

During the copolymerization, it is possible to add one or more polymerization inhibitors in small amounts, for example hydroquinone monomethyl ether. Polymerization inhibitors can advantageously be metered with (B), (C) and, if appropriate, (D). Suitable amounts of polymerization inhibitor are from 0.01 to 1, preferably from 0.05 to 0.5, % by weight, based on the mass of all comonomers. The addition of polymerization inhibitor is particularly preferred when the copolymerization is carried out at above 80° C.

After the end of the addition of (A), (B), (C), if appropriate (D), if appropriate (E) and, if appropriate, initiator, the reaction can be allowed to continue.

The duration of the free radical copolymerization is in general from 1 to 12, preferably from 2 to 9, particularly preferably from 3 to 6, hours.

The duration of the reaction with (E) may be from 1 to 12, preferably from 2 to 9, particularly preferably from 3 to 6, hours.

If the preparation of (b) is carried out in such a way that (A), (B), (C) and, if appropriate, (D) are copolymerized in the presence of the total amount of (E), a total duration of reaction from 1 to 12, preferably from 2 to 10, particularly preferably from 3 to 8, hours is suitable.

The reaction with (E) can be carried out in the absence or presence of catalysts, in particular acidic catalysts, e.g. sulfuric acid, methanesulfonic acid, p-toluenesulfonic acid, n-dodecylbenzenesulfonic acid, hydrochloric acid or acidic ion exchangers.

In a further variant of the process described, the reaction with (E) is carried out in the presence of an entraining agent which forms an azeotrope with the water formed if appropriate in the reaction.

In general, under the conditions of the steps (E) described above, the reaction with the carboxyl groups of the anhydrides (A) and, if appropriate, the carboxyl groups from (D) takes place completely or to a certain percentage. In general, less than 40 mol % of unconverted (E) remain.

It is possible, by methods known per se, for example extraction, to separate unconverted (E) from copolymer obtained by the novel preparation process.

In an embodiment, it is possible to dispense with the further step of separating unreacted (E) from the copolymers prepared. In this embodiment, copolymers are used together with a certain percentage of unreacted (E) for the treatment of fibrous substrates.

Copolymers are obtained by the above-described copolymerization of (A), (B), (C) and, if appropriate, (D). The copolymers obtained can be subjected to a purification by conventional methods, for example reprecipitation or extractive removal of unconverted monomers. If a solvent or precipitating agent was used, it is possible to remove this after the end of the copolymerization, for example by distilling off.

In the present invention, copolymers prepared as described above can be brought into contact with water, the amount of added water being calculated so as to give novel dispersions which have a water content of from 30 to 99.5% by weight, based on the total mass of assistants.

In an embodiment, water is added after the free radical copolymerization and, if appropriate, the reaction with (E), it also being possible for the water to comprise Brønsted acid or, preferably, Brønsted base. Examples of Brønsted acids are sulfuric acid, hydrochloric acid, tartaric acid and citric acid. Examples of Brønsted base are alkali metal hydroxide, for example NaOH and KOH, alkali metal carbonate, for example Na₂CO₃ and K₂CO₃, alkali metal bicarbonate, for example NaHCO₃ and KHCO₃, ammonia, amines, for example trimethylamine, triethylamine, diethylamine, ethanolamine, N,N-diethanolamine, N,N,N-triethanolamine and N-methylethanolamine. The concentration of Brønsted acid or, preferably, Brønsted base is in general from 1 to 20% by weight, based on the sum of water and Brønsted acid or water and Brønsted base.

Water can be added as early as during the free radical copolymerization but is preferably added only toward the end of the free radical copolymerization. If the free radical copolymerization and the reaction with (E) has been carried out in the presence of solvent, it is preferable to first remove the solvent, for example by distilling off, and only thereafter to effect contact with water.

By bringing into contact with water, which if appropriate may comprise Brønsted acid or, preferably, Brønsted base, some or all of the carboxylic anhydride groups present in the copolymer can be hydrolyzed.

After bringing into contact with water, which, if appropriate, may comprise Brønsted acid or, preferably, Brønsted base, the reaction can be allowed to continue at from 20 to 120° C., preferably up to 100° C., in particular for a period of 10 minutes to 48 hours.

In an embodiment of the present invention, water is initially taken at from 50 to 100° C., it also being possible for the water to comprise Brønsted acid or, preferably, Brønsted base, and copolymer which, if appropriate, has been heated to 50 to 120° C. is added by a feed method.

In a further embodiment of the present invention, copolymer is initially taken at from 50 to 120° C. and the water which, if appropriate, has been heated to 50 to 100° C. is added by a feed method, it also being possible for the water to comprise Brønsted acid or, preferably, Brønsted base.

In an embodiment of the present invention, a mixture of water is initially taken at from 50 to 100° C., it also being possible for the water to comprise Brønsted acid or, preferably, Brønsted base and nonionic surfactant, and copolymer which, if appropriate, has been heated to 50 to 120° C. is added by a feed method. Suitable nonionic surfactants are, for example, polyalkoxylated C₁₂-C₃₀-alkanols, preferably C₁₂-C₃₀-alkanols having a degree of alkoxylation from 3 to 30.

In a further embodiment, copolymer is initially taken at from 50 to 120° C. and the mixture comprising water which, if appropriate, has been heated to 50 to 100° C. is added by a feed method, it also being possible for the water to comprise Brønsted acid or, preferably, Brønsted base and nonionic surfactant. A suitable nonionic surfactant is, for example, polyalkoxylated C₁₂-C₃₀-alkanol, preferably C₁₂-C₃₀-alkanol having a degree of alkoxylation of from 3 to 30.

The copolymers described above are usually obtained in the form of aqueous dispersions or aqueous solutions or as such. Aqueous dispersions and solutions of copolymers described above are likewise a subject of the present invention. Novel copolymers can be isolated from novel aqueous dispersions and solutions by methods known per se to a person skilled in the art, for example by evaporation of water or by spray-drying.

The present Application furthermore relates to copolymers obtainable by copolymerization of
(A) at least one ethylenically unsaturated dicarboxylic anhydride, derived from at least one dicarboxylic acid of 4 to 8 carbon atoms,
(B) at least one oligomer of branched or straight-chain C₃-C₁₀-alkene, at least one oligomer having an average molecular weight Mₙ of up to 1200 g/mol,
(C) at least one α-olefin of up to 16 carbon atoms and
(D) optionally at least one further ethylenically unsaturated comonomer,
   and optionally reaction with
(E) at least one compound of the formula I a, I b, I c or I d

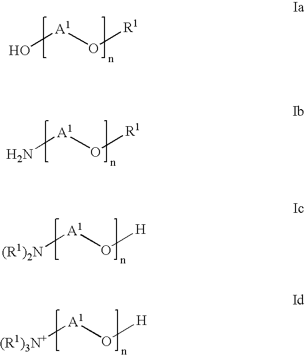

and, if appropriate, subsequent contact with water,
where, in the formulae I a to I d,
A¹ are identical or different C₂-C₂₀-alkylene,
R¹ is linear or branched C₁-C₃₀-alkyl, phenyl or hydrogen, and
n is an integer from 1 to 200.

In novel copolymers, at least one comonomer (C) is particularly preferably selected from isobutene, diisobutene and 1-dodecene.

In an embodiment of the present invention, the molar ratios of comonomers incorporated in the form of polymerized units in the novel copolymer are
(A) in the range from 5 to 60, preferably from 10 to 55, mol %,
(B) in the range from 1 to 95, preferably from 5 to 70, mol % and
(C) in the range from 1 to 60, preferably from 5 to 55, mol % and
(D) in the range from 1 to 70, preferably from 1 to 50, mol %, based in each case on copolymer, the sum of (A), (B), (C) and (D) being 100 mol %, and
(E) in the range from 0 to 50, preferably from 1 to 30, particularly preferably from 2 to 20, mol %, based on all carboxyl groups of the novel copolymer.

The working examples which follow illustrate the invention.

### 1. SYNTHESIS METHOD FOR COPOLYMERIZATION AND PARTIAL ESTERIFICATION

All reactions were carried out under a nitrogen atmosphere, unless stated otherwise.

The K values of the novel copolymers were determined according to H. Fikentscher, Cellulose-Chemie 13 (1932), 58-64 and 761-774 in cyclohexanone at 25° C. and at a polymer concentration of 2% by weight.

### Preparation Method

206 g of polyisobutene having a molecular weight of Mₙ of 550 g/mol and 185 g of diisobutene (mixture of 2,4,4-trimethyl-1-pentene and 2,4,4-trimethyl-2-pentene in a molar ratio of 80:20, determined by ¹H-NMR spectroscopy) were initially taken in a 4 l kettle and heated to 110° C. in a gentle stream of nitrogen. After the temperature of 110° C. had been reached, 184 g of maleic anhydride were metered in the course of 5 hours in liquid form as a melt at about 70° C. and 5.5 g of tert-butyl peroctanoate, dissolved in 25 g of diisobutene (mixture of 2,4,4-trimethyl-1-pentene and 2,4,4-trimethyl-2-pentene), were metered in the course of 5.5 hours. Heating was then continued for one hour at 120° C. Thereafter, the temperature was increased to 160° C. and unconverted diisobutene was distilled off.

The resulting reaction mixture was cooled to 90° C. and at the same time 2400 g of water and 140 g of 50% by weight aqueous sodium hydroxide solution were added. Thereafter, stirring was carried out for 4 hours at 90° C. and cooling to room temperature was then effected. Novel emulsifier (b1) in the form of an aqueous dispersion which had a pH of 6.5 and a water content of 80% by weight was obtained. The K value was 14.7.

### 2. PREPARATION OF NOVEL ASSISTANTS

Emulsifier (b1) was further processed to give novel assistant H1 by mixing 90 g of polyisobutene having a molecular weight Mₙ of 550 g/mol with 10 g of the above-described dispersion of emulsifier (b1) by stirring in a beaker.

Emulsifier (b1) was further processed to give novel assistant H2 by mixing 90 g of polyisobutene having a molecular weight Mₙ of 1000 g/mol with 10 g of the above-described dispersion of emulsifier (b1) by stirring in a beaker.

The novel assistants H1 and H2 were obtained.

### 3. PRODUCTION OF LEATHER

### 3.1 Novel Use of Assistant H1 in the Production of Leather and Comparative Examples

Preliminary remark: Percentages by weight are based on the shaved weight, unless stated otherwise.

100 parts by weight of chrome-tanned cattle hide having a shaved thickness from 1.8 to 2.0 mm were drummed in a rotatable drum having baffles at 30° C. with 100% by weight of water and 2% by weight of a naphthalenesulfonic acid/formaldehyde condensate, prepared according to U.S. Pat. No. 5,186,846, example “Dispersant 1”, over a period of 45 minutes. Thereafter, the liquor was discharged and the leather was washed with 200% by weight of water.

Together with 100% by weight of water, 3% by weight of novel assistant H1 were metered in and drumming was effected. After a drumming time of 30 minutes (30° C.) at 10 revolutions per minute, a sample of the liquor was taken and then 7% by weight of sulfone tanning agent from EP-B 0 459 168, example K1, were added and drumming was effected for a further 45 minutes at 10 revolutions per minute in the drum. 3% by weight of vegetable tanning agent Mimosa®, commercially available from BASF Aktiengesellschaft, were then added and drumming was effected for 40 minutes. 2% by weight of a brown dye mixture which had the following composition were then added:

70 parts by weight of dye from EP-B 0 970 148, example 2.18,
30 parts by weight of Acid Brown 75 (iron complex), Colour Index 1.7.16.

After drumming for a further 40 minutes, acidification to a pH of from 3.6 to 3.8 was effected with formic acid. After a further 20 minutes, the liquor was discharged and washing was effected with 200% by weight of water. The washed leather was sammed, dried and staked and was assessed according to the test criteria specified in table 2.

### 3.2 Novel Use of Assistant H2

Example 3.1 was repeated, except that the novel assistant H2 was used instead of the novel assistant H1.

### 3.3 Comparative Examples C3 and C4

The procedure was as above, except that a comparative assistant prepared according to table 1 was used instead of the novel assistant H1.

TABLE 1
Composition of novel assistants H1 and H2 and
comparative assistants CH3 and CH4

| | | | Water content |
|---|---|---|---|
| Assistant | Oligomer (a) | Emulsifier (b) | [% by wt.] |
| H1 | Polyisobutene with Mₙ = | (b1) | 80 |
| | 550 g/mol | | |
| H2 | Polyisobutene with Mₙ = | (b1) | 80 |
| | 1000 g/mol | | |
| CH3 | Polyisobutene with Mₙ = | n-C₁₂H₂₅—O(CH₂CH₂O)₇H | 80 |
| | 1000 g/mol | | |
| CH4 | Polyisobutene with Mₙ = | n-C₁₂H₂₅—O(CH₂CH₂O)₇H | 80 |
| | 550 g/mol | | |

The water content is based in each case on the total mass of assistant or comparative assistant.

The stability of the emulsion (liquor) was evaluated using ratings from 1 to 5 after a standing time of 90 minutes.

Handle of the surface, morphology of the flesh side, softness, dyeing and penetration were evaluated by teams of testers according to ratings from 1 to 5.

TABLE 2
Result of the treatment of semifinished products: testing of performance
characteristics

| | Stability of | Handle of | Morphology of | | | Dyeing |
|---|---|---|---|---|---|---|
| No. | emulsion | surface | flesh side | Penetration | Softness | (levelness) |
| 1 | 1 | dry | fine,dry | 1.5 | 2 | 2 |
| 2 | 1 | slight friction | fine, dry | 2 | 1 | 2 |
| C3 | 5 | very fatty | compact, fatty | 4 | 4 | 3.5 |
| C4 | 4 | fatty | compact, fatty | 3.5 | 3.5 | 3 |

1: A process for the treatment of a fibrous substrate, comprising treating the fibrous substrate with
(a) at least one oligomer of branched or straight-chain C₃-C₁₀-alkene comprising an average molecular weight Mₙ of up to 1200 g/mol, and
(b) at least one emulsifier obtained by copolymerization of
(A) at least one ethylenically unsaturated dicarboxylic anhydride, obtained from at least one dicarboxylic acid comprising 4 to 8 carbon atoms,
(B) at least one oligomer of branched or straight-chain C₃-C₁₀-alkene comprising an average molecular weight Mₙ of up to 1200 g/mol,
(C) at least one α-olefin comprising up to 16 carbon atoms and
(D) optionally at least one further ethylenically unsaturated comonomer, and optionally reaction with
(E) at least one compound of the formula I a, I b, I c or I d 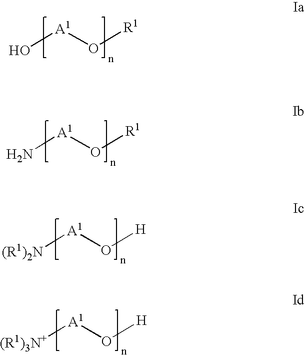
and optionally, treating the fibrous substrate with water,
wherein, in the formulae I a to I d,
A¹ are identical or different C₂-C₂₀-alkylene,
R¹ is, each independently, a linear or branched C₁-C₃₀-alkyl, a phenyl or a hydrogen, and
n is an integer from 1 to 200.

2: The process according to claim 1, wherein the preparation of oligomer (B) starts from branched C₄-C₁₀-alkene.

3: The process according to claim 1, wherein the preparation of the at least one emulsifier (b) starts from oligomers which were prepared using branched C₄-C₁₀-olefin.

4: The process according to claim 1, wherein the at least one oligomer (a) is polyisobutene.

5: The process according to claim 1, wherein the at least one oligomer (B) is polyisobutene.

6: The process according to claim 1, wherein the weight ratio of (a) to (b) ranges from 1:1 to 100:1.

7: The process according to claim 1, wherein, (b) comprises (E), and wherein in (b)
(A) in the range from 5 to 60 mol %,
(B) in the range from 1 to 95 mol %,
(C) in the range from 1 to 60 mol %,
(D) in the range from 0 to 70 mol %, based in each case on copolymer, the sum of (A), (B), (C) and (D) being 100 mol %, and
(E) in the range from 0 to 50 mol %, based on all carboxyl groups of copolymer.

8: The process according to claim 1, wherein the process is carried out in aqueous liquor.

9: The process according to claim 1, comprising (D), wherein (D) is selected from the group consisting of ethylenically unsaturated C₃-C₈-carbonyl compounds of the formula II 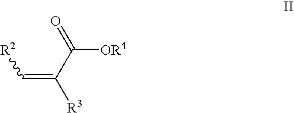
carboxamides of the formula III 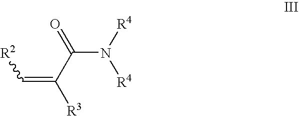
acyclic amides of the formula IV a, cyclic amides of the formula IV b 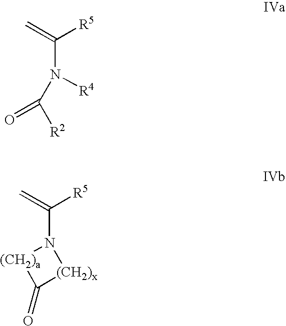
C₁-C₂₀-alkyl vinyl ethers,
nitrogen-containing aromatic compounds comprising at least one N-vinyl group,
α,β-unsaturated nitrites,
alkoxylated unsaturated ethers of the formula V 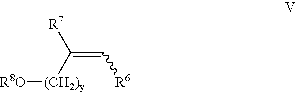
esters or amides of the formula VI 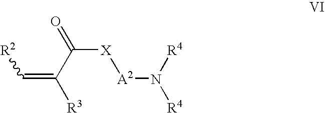
unsaturated esters of the formula VII 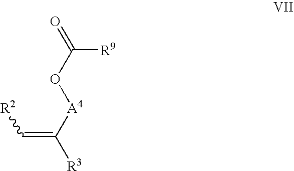
vinylaromatic compounds of the formula VIII 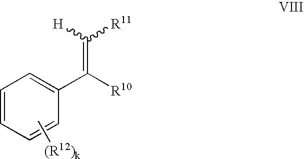
comonomers comprising phosphate, comonomers comprising phosphonate, comonomers comprising sulfate comonomers comprising sulfonate,
and α-olefins comprising 18 to 40 carbon atoms,
wherein, in the formulae,
R² and R³ are identical or different and are selected from the group consisting of hydrogen, straight-chain C₁-C₅-alkyl, branched chain C₁-C₅-alkyl and COOR⁴,
R⁴ are identical or different and are selected from the group consisting of hydrogen, branched chain C₁-C₂₂-alkyl, and straight-chain C₁-C₂₂-alkyl,
R⁵ is hydrogen or methyl,
x is an integer from 2 to 6,
y is an integer from 0 to 1,
a is an integer from 0 to 6,
R⁶ and R⁷ are identical or different and are selected from the group consisting of hydrogen, straight-chain C₁-C₁₀-alkyl, and branched chain C₁-C₁₀-alkyl,
X is oxygen or N—R⁴,
R⁸ is [A³-O]ₙ—R⁴,
R⁹ are identical or different and are selected from the group consisting of hydrogen, straight-chain C₁-C₁₀-alkyl, and branched chain C₁-C₁₀-alkyl,
R¹⁰ and R¹¹, independently of one another, are hydrogen, methyl or ethyl,
R¹² is selected from the group consisting of methyl and ethyl,
k is an integer from 0 to 2,
A² and A³ are C₂-C₂₀-alkylene, and
A⁴ is C₁-C₂₀-alkylene or a single bond.

10: The process according to claim 1, wherein the fibrous substrate is selected from the group consisting of leather, textile, paper, board, artificial leather, alcantara, leather fiber material and combinations thereof.

11: The process according to claim 10, wherein the fibrous substrate comprises leather, and wherein the leather is based on wet-white.

12: The process according to claim 1, wherein the at least one α-olefin (C) is selected from the group consisting of isobutene, diisobutene, 1-dodecene and combinations thereof.

13: A fibrous substrate treated by a process according to claim 1.

14: The fibrous substrate according to claim 13, wherein the fibrous substrate is leather.

15: The leather according to claim 14, wherein said leather is based on wet-white.

16: A method of making an article, comprising forming the article with the fibrous substrate according to claim 13.

17: An assistant comprising
(a) at least one oligomer of branched or straight-chain C₃-C₁₀-alkene comprising an average molecular weight Mₙ of up to 1200 g/mol, and
(b) at least one emulsifier obtained by copolymerization of
(A) at least one ethylenically unsaturated dicarboxylic anhydride, obtained from at least one dicarboxylic acid comprising 4 to 8 carbon atoms,
(B) at least one oligomer of branched or straight-chain C₃-C₁₀-alkene, comprising an average molecular weight Mₙ of up to 1200 g/mol,
(C) at least one α-olefin comprising up to 16 carbon atoms and
(D) optionally at least one further ethylenically unsaturated comonomer, and optionally reaction with
(E) at least one compound of the formula I a, I b, I c or I d 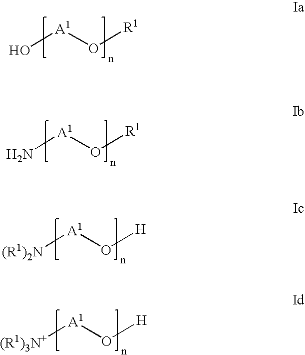
and optionally, water,
where, in the formulae I a to I d,
A¹ are identical or different C₂-C₂₀-alkylene,
R¹ is linear or branched C₁-C₃₀-alkyl, phenyl or hydrogen, and
n is an integer from 1 to 200.

18: The assistant according to claim 17, wherein the at least one α-olefin (C) is selected from the group consisting of isobutene, diisobutene, 1-dodecene, and combinations thereof.

19: A copolymer obtained by copolymerization of
(A) at least one ethylenically unsaturated dicarboxylic anhydride, obtained from at least one dicarboxylic acid comprising 4 to 8 carbon atoms,
(B) at least one oligomer of branched or straight-chain C₃-C₁₀-alkene comprising an average molecular weight Mₙ of up to 1200 g/mol,
(C) at least one α-olefin comprising up to 16 carbon atoms and
(D) optionally at least one further ethylenically unsaturated comonomer, and reaction with
(E) at least one compound of the formula I a, I b, I c or I d 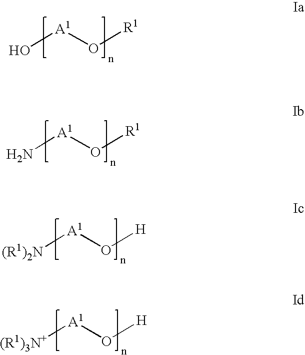
wherein the copolymer is optionally, subsequently contacted with water,
where, in the formulae I a to I d,
A¹ are identical or different C₂-C₂₀-alkylene,
R¹ is independently, a linear or branched C₁-C₃₀-alkyl, phenyl or hydrogen, and
n is an integer from 1 to 200.

20: The copolymer according to claim 19, wherein the at least one α-olefin (C) is selected from the group consisting of isobutene, diisobutene, 1-dodecene, and combinations thereof.

21: An aqueous dispersion comprising water and the copolymer of claim 19.

22: The aqueous dispersion according to claim 21, which additionally comprises
(a) at least one oligomer of branched or straight-chain C₃-C₁₀-alkene comprising an average molecular weight Mₙ of up to 1200 g/mol.
